(19) United States
(12) Patent Application Publication
(10) Pub. No.: US 2004/0203277 A1
(43) Pub. Date: Oct. 14, 2004

(54) Power outlet with winding wire function

(76) Inventor: Chao Chuan Chien, Hsin-Chuang City (TW)

Correspondence Address: QUINTERO LAW OFFICE, 1617 BROADWAY, 3RD FLOOR, SANTA MONICA, CA, 90404, US

(21) Appl. No.: 10/413,228

(22) Filed: Apr. 14, 2003

(51) Int. Cl. H01R 13/72

(52) U.S. Cl. 439/501

(57) ABSTRACT

A power outlet with winding wire function, comprising: a frame having two perpendicular sides and two horizontal sides, wherein the length of the two perpendicular sides are longer than the length of the two horizontal sides; and a power outlet module that positioned in one of the perpendicular sides having at least one outlet and a plug; upon assembling the frame and the power outlet module together, user could plug a outlet of a power cord in the plug of the power outlet module, and then plug a plug of the power cord in a power outlet so as to provide power by the outlet.

### FIELD OF THE INVENTION

The present invention relates generally to the field of power outlet and, more particularly, to power outlet with winding wire function so that user can use conveniently and collect easily.

### BACKGROUND OF THE INVENTION

Generally speaking, a power outlet is appeared in a building constantly for providing power required to electric appliance. The power outlet may combine with a power cord for providing power required to electric appliance that placed more far. However, the above-mentioned power outlet is not collected easily, in general, the power outlet in accordance with the prior art folded up and then bound by a wire. This is not conveniently to user. There is a H-shape winding wire frame appeared in the market, which could wind wire on the H-shape frame so that user can use conveniently and collect easily. However, the H-shape winding wire frame doesn't comprise any outlet, therefore, if the length of the power cord is not enough, the power cord could not extend any more.

As a result, a power outlet with winding wire function that could make user used conveniently and collected easily is needed.

### SUMMARY OF THE INVENTION

It is an object of the present invention to provide a power outlet with winding wire function so that user can use conveniently and collect easily.

In accordance with one embodiment of the invention, a power outlet with winding wire function is provided comprising: a frame having two perpendicular sides and two horizontal sides, wherein the length of the two perpendicular sides are longer than the length of the two horizontal sides; and a power outlet module that positioned in one of the perpendicular sides having at least one outlet and a plug; upon assembling the frame and the power outlet module together, user could plug a outlet of a power cord in the plug of the power outlet module, and then plug a plug of the power cord in a power outlet so that the outlet could provide power to the electric appliance.

### BRIEF DESCRIPTION OF THE DRAWINGS

The novel features believed characteristic of the invention are set forth with particularity in the appended claims. The invention itself, however, as well as a preferred mode of use, further objectives and advantages thereof, will be best understood by reference to the following detailed description when read in conjunction with the accompanying drawings, wherein:

FIG. 1 depicts an assembly view of a power outlet with winding wire function prior winding wire in accordance with one embodiment of the present invention;

FIG. 2 depicts an assembly view of a power outlet with winding wire function after winding wire in accordance with one embodiment of the present invention; and

FIG. 3 depicts an assembly view of a power outlet with winding wire function combines with a support and a handle in accordance with one embodiment of the present invention.

### DETAILED DESCRIPTION OF THE PREFERRED EMBODIMENTS

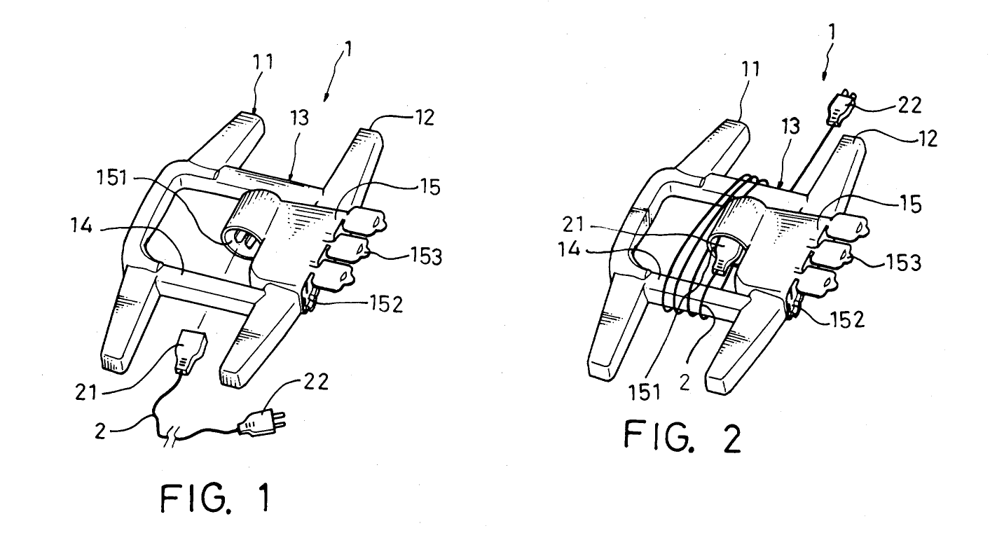

Referring first to Fig.1, there is an assembly view of a power outlet with winding wire function prior winding wire in accordance with one embodiment of the present invention. The power outlet with winding wire function comprises: a frame 1; and a power outlet module 15.

Wherein, the frame 1 having two perpendicular sides 11, 12 and two horizontal sides 13, 14, wherein the length of the two perpendicular sides 11, 12 are longer than the length of the two horizontal sides 13, 14. The power outlet module 15 is positioned in one of the perpendicular sides 12 and inside a space forming by the two horizontal sides 13, 14 having at least one outlet 152 and a plug 151, wherein the plug 151 of the power outlet module 15 is positioned between the two horizontal sides 13, 14 and has a protect housing 154 in shape of cone for protecting the plug 151. The at least one outlet 152 of the power outlet module 15 further comprises a cover 153 that covered over the outlet 152 to prevent water or dust intruding into the outlet 152.

Referring to FIG. 2 depicts an assembly view of a power outlet with winding wire function after winding wire in accordance with one embodiment of the present invention. Upon assembling the frame 1 and the power outlet module 15 together, user could plug a outlet 21 of a power cord 2 in the plug 151 of the power outlet module 15, and then plug a plug 22 of the power cord 2 in a power outlet (not shown) so as to provide power required to electric appliance that placed more far by the outlet. While the power outlet with winding wire function used completely, user could wind wire of the power cord 2 on the frame 1 so that user can use conveniently and collect easily.

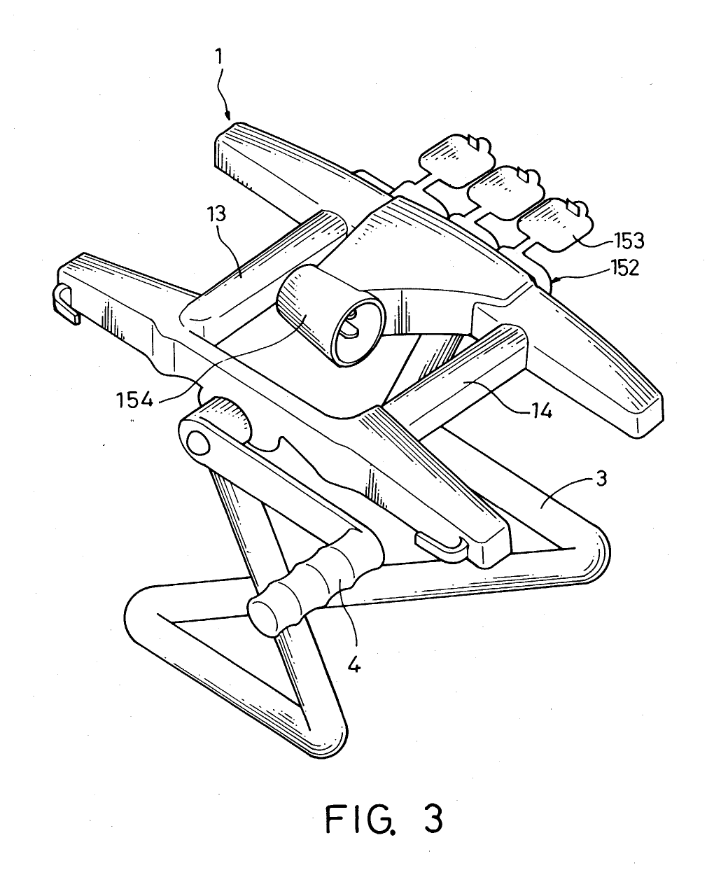

Referring to FIG. 3 depicts an assembly view of a power outlet with winding wire function combines with a support and a handle in accordance with one embodiment of the present invention. The power outlet with winding wire function further comprises a support 3 and a handle 4, wherein the support 3 combines with the two perpendicular sides 11, 12 below a central region of the two perpendicular sides 11, 12 for supporting the frame 1, wherein the length of the support 3 is longer than one half length of the perpendicular sides 11, 12, and the shape of the support 3 is L shape preferably. The handle 4 combined with one perpendicular side 11 of the power outlet module 15, therefore, user could move around the frame 1 by rotating the handle 4 so as to wind the power cord 2 on the two horizontal sides 13, 14 of the frame 1.

As a result, a power outlet with winding wire function in accordance with one embodiment of the present invention could make user used conveniently and collected easily, and provide power required to electric appliance that placed more far by the outlet.

The description of the present invention has been presented for the purposes of illustration and description, but is not intended to be exhaustive or limited to the invention in the form disclosed. Many modifications and variations will be apparent to those of ordinary skill in the art. The embodiment was chosen and described to best explain the principles of the invention, the practical application, and to enable others of ordinary skill in the art to understand the invention for various embodiments with various modifications as suited to the particular use contemplated. While the invention has been described with reference to a preferred embodiment thereof, it is to be understood that modifications or variations may be easily made without departing from the spirit of this invention, which is defined by the appended claims.

What is claimed is:

1. A power outlet with winding wire function, comprising:
a frame having two perpendicular sides and two horizontal sides, wherein the length of said two perpendicular sides are longer than the length of said two horizontal sides; and
a power outlet module that positioned in one of said perpendicular sides having at least one outlet and a plug;
upon assembling said frame and said power outlet module together, user could plug a outlet of a power cord in said plug of said power outlet module, and then plug a plug of said power cord in a power outlet so as to provide power by said outlet.

2. A power outlet with winding wire function as claimed in claim 1, wherein the power outlet further comprises a support that combined with said two perpendicular sides below a central region of said two perpendicular sides for supporting said frame, wherein the length of said support is longer than one half length of said perpendicular sides.

3. A power outlet with winding wire function as claimed in claim 1, wherein the shape of said support is L shape preferably.

4. A power outlet with winding wire function as claimed in claim 2, wherein the power outlet further comprising a handle that combined with one perpendicular side of the power outlet module, therefore, user could move around said frame by rotating said handle so as to wind said power cord on said two horizontal sides of said frame.

5. A power outlet with winding wire function as claimed in claim 1, wherein the power outlet module is positioned in one of the perpendicular sides and inside a space formed by said two horizontal sides.

6. A power outlet with winding wire function as claimed in claim 1, wherein the plug of said power outlet module is positioned between said two horizontal sides and has a protect housing in shape of cone.

7. A power outlet with winding wire function as claimed in claim 1, wherein the at least one outlet of said power outlet module further comprises a cover that covered over said outlet to prevent water or dust intruding into said outlet.
